(19) United States
(12) Patent Application Publication
(10) Pub. No.: US 2009/0112852 A1
(43) Pub. Date: Apr. 30, 2009

(54) USER MANUAL SUPPORTING METHOD AND APPARATUS USING ERROR PATTERN ANALYSIS

(75) Inventors: Hyeon Jin KIM, Daejeon (KR); Young Jik LEE, Daejeon (KR); Kyoung PARK, Daejeon (KR); Seung Jo BAE, Daejeon (KR); Choong Gyoo LIM, Daejeon (KR); Chang Woo YOON, Daejeon (KR); Dong Hwan SON, Daejeon (KR); Kwang-Hyun SHIM, Daejeon (KR); Shin Young AHN, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics amd Telecommunications Research Institute, Daejeon (KR)

(21) Appl. No.: 12/127,341

(22) Filed: May 27, 2008

(30) Foreign Application Priority Data
Oct. 25, 2007 (KR) 10-2007-0107723

(51) Int. Cl. G06F 3/048; G06F 17/30

(52) U.S. Cl. 707/5; 715/708; 707/E17.014

(57) ABSTRACT

A user manual supporting method for use in an electronic appliance includes converting a series of operations performed by the user to operate the electronic appliance and converting the operations into a pattern of user operation sequence, and checking if an error is present in the pattern of user operation sequence to retrieve a pattern of erroneous operation sequence corresponding to the pattern of user operation sequence having the error. Thereafter, a manual content associated with the pattern of erroneous operation pattern is extracted and the extracted manual content is provided to the user. The manual content the manual content includes text and/or graphics information for notifying the user of a missing operation in the pattern of user operation sequence, or for guiding a normal operation against the pattern of erroneous operation sequence.

### CROSS-REFERENCE(S) TO RELATED APPLICATION

The present invention claims priority of Korean Patent Application No. 10-2007-0107723, filed on Oct. 25, 2007, which is incorporated herein by reference.

### FIELD OF THE INVENTION

The present invention relates to a user manual support technique for an electronic appliance using error pattern analysis and, more particularly, to a manual supporting method and apparatus for use in an electronic appliance capable of presenting a user content to guide a user for a normal operation, upon detection of an error made by the user without familiarity with the electronic appliance, by analyzing the error.

### BACKGROUND OF THE INVENTION

Human-computer interaction (HCI) provides interaction between users and computers, and aims to design and develop computer systems that are easy to use, safe, and functionally excellent.

For example, when a computer system provided with a speech interface and display interface is operated by a user, the computer system can guide the user during interaction by displaying a section of a particular user manual or by generating sounds corresponding to the user manual. Hence, the user can interact with an unfamiliar application without difficulty.

Several techniques have been proposed to present a user manual to a user utilizing an electronic appliance such as a computer system. For example, one of the techniques discloses a method of presenting a user manual in speech using information internal to a device through interactive speech input and output. Another technique discloses a method of presenting a user manual in speech using external information obtained through the Internet.

In the former method disclosed above, user's speech is analyzed through speech recognition, linguistic and dialog analysis, and then a section of the manual corresponding to the speech is provided through an output unit having a visual and speech interface. This method has an advantage of presenting a section of the manual to the user who has difficulty in reading the manual. However, this method increases complexity of the product because the product must include facilities necessary for speech recognition, linguistic and dialog analysis, speech synthesis, and manual database. Further, to consult the manual using speech, the user may have to remember keywords for search or commands embedded in the manual database. That is, this method leaves something to be desired in providing an intuitive user interface.

In the latter method disclosed above, when a user sends an information request in the form of text or speech through a computer, telephone or mobile phone, an information searcher searches and processes manual information and delivers a requested manual section to the user. In this method, an information specialist is involved, and reliable information can be provided. However, a communication facility connectable to the Internet or to a telephone network is necessary, and the cost to obtain information is high.

As described above, in conventional user manual supporting methods using speech, the user may have to remember keywords or commands, or have to equip a communication facility and pay the cost of manual information.

### SUMMARY OF THE INVENTION

Therefore, an object of the present invention is to provide a user manual supporting method and apparatus capable of analyzing the pattern of an error made by the user without familiarity with an electronic appliance, recognizing the pattern of the error and providing a manual content to remedy the error to the user.

In accordance with an aspect of the present invention, there is provided a user manual supporting method for use in an electronic appliance, including:

converting a series of operations performed by the user to operate the electronic appliance into a pattern of user operation sequence;

checking a operation pattern database having a pattern of normal operation sequence and a pattern of erroneous operation sequence stored therein if an error is present in the pattern of user operation sequence to retrieve a pattern of erroneous operation sequence corresponding to the pattern of user operation sequence having the error;

extracting a manual content associated with the pattern of erroneous operation pattern; and

providing the manual content to the user.

In accordance with another aspect of the present invention, there is provided a user manual supporting apparatus for use in an electronic appliance, including:

an operation sequence converting unit for converting a series of operations performed by a user to operate the electronic appliance into a pattern of user operation sequence;

an operation pattern database for storing therein a pattern of normal operation sequence and a pattern of erroneous operation sequence;

an error detection unit determining whether the pattern of user operation sequence follows the pattern of normal operation sequence or the pattern of erroneous operation sequence to find an error in the pattern of user operation sequence;

a response generation unit for providing a manual content associated with the pattern of erroneous operation sequence when the pattern of user operation sequence follows the pattern of erroneous operation sequence; and

an output unit for providing the manual content to the user.

### BRIEF DESCRIPTION OF THE DRAWINGS

The above and other objects and features of the present invention will become apparent from the following description of embodiments given in conjunction with the accompanying drawings, in which:

FIG. 1 is a schematic view illustrating an interface for the interaction between a user and an electronic appliance incorporating a user manual supporting apparatus in accordance with an embodiment of the present invention;

FIG. 2 is a block diagram showing the user manual supporting apparatus incorporated in the digital electronic appliance shown in FIG. 1; and

FIG. 3 is a flow chart illustrating a user manual supporting method in accordance with an embodiment of the present invention.

### DETAILED DESCRIPTION OF THE EMBODIMENTS

Hereinafter, embodiments of the present invention will be described in detail with reference to the accompanying drawings.

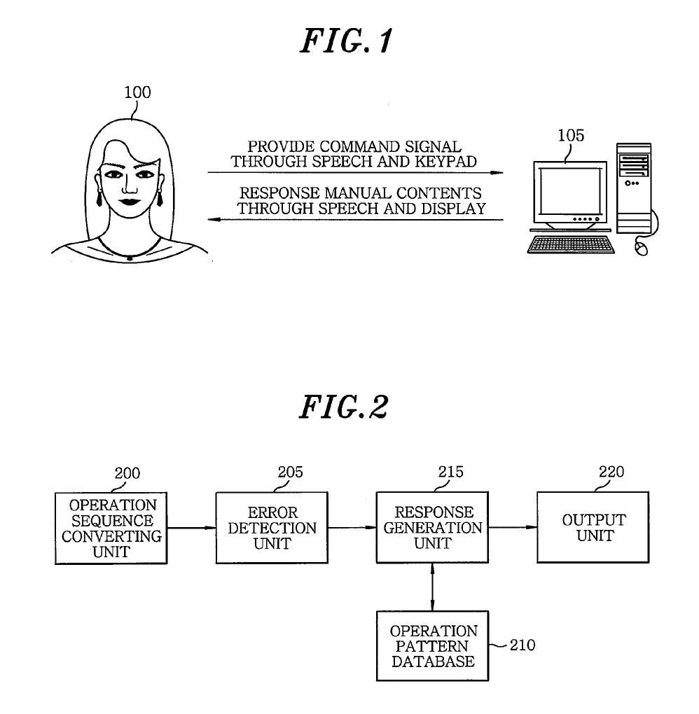

FIG. 1 is a schematic view illustrating an interface for the interaction established between a user and a digital electronic appliance incorporating a user manual supporting apparatus in accordance with an embodiment of the present invention.

As shown in FIG. 1, a user 100 inputs a control command to an electronic appliance 105 using, e.g., speech, a keypad, or a touch screen on the electronic appliance 105. The electronic appliance 105 then recognizes the control command through speech recognition or an interpretation thereof, and outputs a corresponding user manual in the form of speech through a voice output unit or in the form of text through a display unit. Accordingly, the user 100 can interactive with the electronic appliance 105 using the user manual guided by the speech or the display unit.

FIG. 2 is a block diagram illustrating the manual supporting apparatus incorporated in the digital electronic appliance 105 shown in FIG. 1. In this regard, components in the electronic appliance 105 will not be described and illustrated, but components of the manual supporting apparatus shown in FIG. 2.

The manual supporting apparatus includes an operation sequence converting unit 200, an error detection unit 205, an operation pattern database 210, a response generation unit 215, and a manual output unit 220.

The operation sequence converting unit 200 receives a series of operations (or actions) performed by a user 100 against the electronic appliance 105 and converts the operations into a pattern of user operation sequence. The series of operations may be made by any input means such as speech recognition, keypad manipulation, or button manipulation on the electronic appliance 105.

In case where the series of user operations is made by the manipulation of buttons, the manipulation of buttons is converted into a pattern of user operation sequence therefor. For example, assuming that the electronic appliance 105 includes a digital door rock, in order to open a door having the digital door lock, the user 100 will manipulate the digital door lock by pressing an OPEN button, rotating a door knob while pulling or pushing the door. The operation sequence converting unit 200 converts these actions into a pattern of operation sequence such as “OPEN button press door knob rotate”. The format of the pattern of user operation sequence is identical to that of a record in the operation pattern database 210.

The operation pattern database 210 stores therein patterns of normal operation sequences for mainly-used functions of the electronic appliance 105, and frequently occurring patterns of erroneous operation sequences for the mainly-used functions, in the form of an automaton.

The error detection unit 205 analysis the pattern of user operation sequence provided from the operation sequence converting unit 200 to check the presence of an error in the pattern of user operation sequence. More specifically, the error detection unit 205 retrieves the operation pattern database 210 to determine whether the pattern of user operation sequence comply the pattern of normal operation sequence or the pattern of erroneous operation sequence by comparing the pattern of user operation sequence with the pattern of normal operation sequence and the pattern of erroneous operation sequence. If an error is present, or if the pattern of user operation sequence follows the pattern of erroneous operation sequence, the error detection unit 205 allows the response generation unit 215 to return a manual content for guiding a normal operation. However, if error is not present, the error detection unit 205 allows the response generation unit 215 to return a comment such as an OK symbol notifying that the pattern of user operation sequence is correct.

In the error detection unit 205, the error is checked using a finite automaton. That is, the error detection unit 205 performs a partial recognition with respect to the automaton for the patterns of user operation sequence, normal operation sequence and erroneous operation sequence to find the error.

Further, if a pattern of erroneous operation sequence not stored in the operation pattern database 210 is input from the operation sequence converting unit 200, the error detection unit 205 stores additionally the pattern of erroneous operation sequence in the operation pattern database 210 as a pattern of new erroneous operation sequence, and creates a manual content to guide a normal operations and/or illustrating one or more missing operation in the pattern of new erroneous operation sequence.

For example, to open the door having the digital door lock, if the user performs a sequence of operations “OPEN button press door knob rotate”, the error detection unit 205 finds a corresponding pattern of to the pattern of user operation sequence from the operation pattern database 210, compares the pattern of user operation sequence with the pattern found from the operation pattern database 210 to check the presence of an error the pattern of user operation sequence. If an error is present, the error detection unit 205 determines which portion of operations led to the error.

Table 1 is an example of a schema illustrating a pattern of normal operation sequence and a pattern of erroneous operation sequence for opening a door having a digital door lock, which is stored in the operation pattern database 210.

TABLE 1

| Pattern | Operation | | | |
|---|---|---|---|---|
| Number | Command | Operation Pattern | Class | Manual ID |
| 1 | @Door_Open | @OPEN_button_Click@Door_push | error | 10_1 |
| 2 | @Door_Open | @OPEN_button_Click@Master_{—} | normal | 10 |
| | | Card_touch@Door_push | | |

For example, in order to open the door, the user has to follow the operation pattern of serial number 2: @OPEN_button_Click (press the ‘OPEN’ button of the digital door lock)→@Master_Card_touch (touch the master card key to on the digital door lock)→@Door_push (push the door knob). In the case where the user tends to fail in the user operations related to the master card key, a pattern of user operation sequence having a pattern number 1 is coded and stored in the operation pattern database 210 on the basis of patterns of errors made by the user.

If the user follows a pattern of normal operation sequence, the error detection unit 205 returns an OK symbol for continued manipulation of the electronic appliance 105. If the user follows a pattern of erroneous operation sequence, the error detection unit 205 returns a manual identifier (ID) associated with the pattern of erroneous operation sequence, e.g, ‘10_{—}1’ as noted in Table 1.

The response generation unit 215 stores manual contents associated with the manual IDs. In response to a manual ID provided from the error detection unit 205, the response generation unit 215 extracts a manual content corresponding to the manual ID and provides the manual content to the information unit 220.

The manual content includes text and/or graphics information for notifying the user of a missing operation in a user operation sequence, and/or for guiding a normal operation against an erroneous operation sequence.

The output unit 220 provides the manual content extracted by the response generation unit 215 to the user. If the electronic appliance 105 has a voice output unit, the output unit 220 converts the manual content for the user manual into an acoustic speech signal through text-to-speech (TTS) synthesis, and outputs the acoustic speech signal through the voice output unit, thereby providing the user with an effective error correction measure. If the electronic appliance 105 has a display unit without a voice output unit, the output unit 220 displays the manual contents on the display unit. If the electronic appliance 105 has a voice output unit and a display unit, the output unit 220 outputs the manual section contents through the voice output unit and display unit.

In addition, if the manual content includes both text information and graphics information, the graphics information is output through the display unit together with the text information.

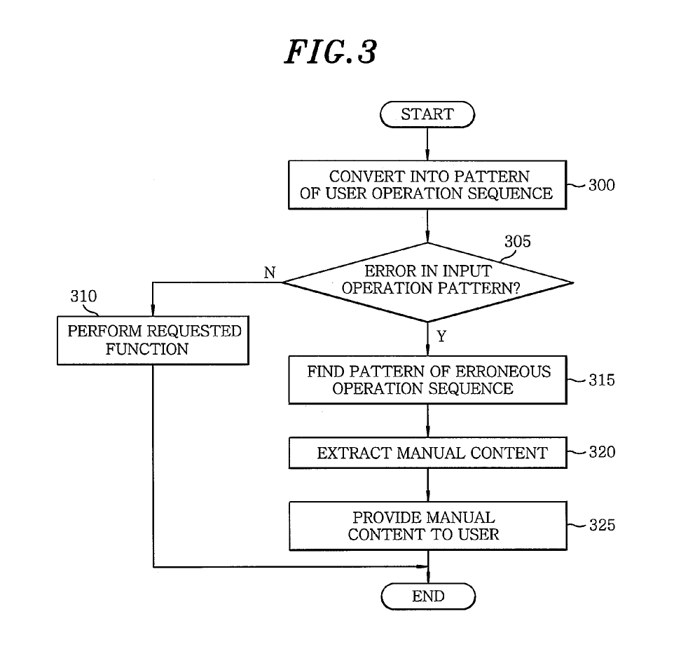

FIG. 3 is a flow chart illustrating a user manual supporting method in accordance with an embodiment of the present invention.

First, at step 300, upon manipulation of the electronic appliance 105, the operation sequence converting unit 200 receives and converts a series of operations performed by the user into a pattern of user operation sequence, and sends the pattern of user operation sequence to the error detection unit 205.

At step 305, the error detection unit 205 checks the presence of an error in the pattern of user operation sequence with reference to the operation pattern database 210 by determining whether the pattern of user operation sequence follows a normal operation pattern or an erroneous operation pattern.

If it is checked at the step 305 that an error is not present in the pattern of user operation sequence, a control process advances to step 310 where the electronic appliance 105 performs a normal function requested by the operation sequence.

If, however, it is checked at step 305 that an error is present in the pattern of user operation sequence, the error detection unit 205 searches the operation pattern database 210 to find the pattern of erroneous operation sequence corresponding to the pattern of user operation sequence having the error at step 315.

Thereafter, at step 320, the error detection unit 205 extracts a manual identifier associated with the pattern of erroneous operation sequence, and then sends the extracted manual ID to the response generation unit 215.

At step 325, the response generation unit 215 extracts a manual content corresponding to the manual ID, and sends the extracted manual contents to the output unit 220, which then outputs the manual section contents through a voice output unit or a display unit.

As apparent from the above description, the present invention provides a user manual supporting method and apparatus, wherein an error made by a user using an electronic appliance is detected through error pattern analysis and the manual contents corresponding to the detected error are provided to the user through a voice output unit or display unit.

While the invention has been shown and described with respect to the preferred embodiments, it will be understood by those skilled in the art that various changes and modifications may be made without departing from the scope of the invention as defined in the following claims.

What is claimed is:

1. A user manual supporting method for use in an electronic appliance, comprising:
converting a series of operations performed by the user to operate the electronic appliance into a pattern of user operation sequence;
checking a operation pattern database having a pattern of normal operation sequence and a pattern of erroneous operation sequence stored therein if an error is present in the pattern of user operation sequence to retrieve a pattern of erroneous operation sequence corresponding to the pattern of user operation sequence having the error;
extracting a manual content associated with the pattern of erroneous operation pattern; and
providing the manual content to the user.

2. The user manual supporting method of claim 1, wherein the step of checking if an error is present in the pattern of user operation sequence comprises:
determining whether the pattern of user operation sequence follows the pattern of normal operation sequence or the pattern of erroneous operation sequence; and
retrieving the pattern of erroneous operation sequence corresponding to the pattern of user operation sequence having the error, if the pattern of user operation sequence follows the pattern of erroneous operation sequence.

3. The user manual supporting method of claim 1, wherein the manual content comprises text and/or graphics information for notifying the user of a missing operation in the series of user operations.

4. The user manual supporting method of claim 1, wherein the manual content comprises text and/or graphics information for guiding a normal operation against the erroneous operation pattern.

5. The user manual supporting method of claim 1, wherein each of the pattern of user operation sequence, the pattern of normal operation sequence and the pattern of erroneous operation sequence has a form of an automaton; and
wherein the error is detected by a partial recognition in the automaton for the patterns of user operation sequence, normal operation sequence and erroneous operation sequence.

6. The user manual supporting method of claim 1, further comprising:
storing, if the pattern of user operation sequence is the pattern of erroneous operation sequence not present in the operation pattern database, the pattern of operation sequence in the operation pattern database as a pattern of new erroneous operation sequence; and
creating a manual content associated with the pattern of new erroneous operation sequence.

7. A user manual supporting apparatus for use in an electronic appliance, comprising:
an operation sequence converting unit for receiving a series of operations performed by a user to operate the electronic appliance and converting the operations into a pattern of user operation sequence;
an operation pattern database for storing therein a pattern of normal operation sequence and a pattern of erroneous operation sequence;
an error detection unit determining whether the pattern of user operation sequence follows the pattern of normal operation sequence or the pattern of erroneous operation sequence to find an error in the pattern of user operation sequence;
a response generation unit for providing a manual content associated with the pattern of erroneous operation sequence when the pattern of user operation sequence follows the pattern of erroneous operation sequence; and
an output unit for providing the manual content to the user.

8. The user manual supporting apparatus of claim 7, wherein the manual content comprises text and/or graphics information for notifying the user of a missing operation in the pattern of user operation sequence.

9. The user manual supporting apparatus of claim 7, wherein the manual content comprises text and/or graphics information for guiding a normal operation against the pattern of erroneous operation sequence.

10. The user manual supporting apparatus of claim 7, wherein each of the pattern of user operation sequence, the pattern of normal operation sequence and the pattern of erroneous operation sequence has a form of an automaton; and wherein the error detection unit performs a partial recognition with respect to the automaton for the patterns of user operation sequence, normal operation sequence and erroneous operation sequence to find the error.

11. The user manual supporting apparatus of claim 7, wherein the error detection unit stores, if the pattern of user operation sequence is the pattern of erroneous operation sequence not present in the operation pattern database, the pattern of user operation sequence in the operation pattern database as a pattern of new erroneous operation sequence, and creates a manual content associated with the pattern of new erroneous operation sequence.
